(19) United States
(12) Patent Application Publication
(10) Pub. No.: US 2025/0215915 A1
(43) Pub. Date: Jul. 3, 2025

(54) Blind rivet having embossed structure

(71) Applicant: Chun-Ju YEN, Kaohsiung (TW)

(72) Inventor: Chun-Ju YEN, Kaohsiung (TW)

(21) Appl. No.: 18/400,426

(22) Filed: Dec. 29, 2023

(51) Int. Cl. F16B 19/10

(52) U.S. Cl. CPC F16B 19/1063

(57) ABSTRACT

A blind rive includes a mandrel, a rivet body, and a magnetic washer having a circular arc angle. The mandrel includes a mandrel head and a shank. The shank includes a grip section, a groove section, and a pull section having a reverse tapered surface. The mandrel head is connected to one side of the grip section of the shank. The end surface of the mandrel head that is connected to one side of the shank has a circular arc surface. The grip section is the portion of shank close to the mandrel head. The groove section is disposed on the shank and connected to the grip section. The pull section has a reverse tapered surface disposed on the shank and connected to the groove section. The rivet body includes a through hole matching the mandrel, a rivet head, and a protruding edge structure.

### FIELD OF THE INVENTION

The invention relates to blind rivets and more particularly to a blind rivet having an embossed structure and longitudinal restraint and construction method thereof.

### BACKGROUND OF THE INVENTION

The mandrel of a blind rivet of the prior art overall has a relatively longer mandrel. Due to the fact that the gripping force of the pull section of the mandrel of the prior art for pulling is insufficient, the gripping force can be improved by increasing the length of the pull section of the prior art. As a result, the overall length of the mandrel of the prior art becomes longer and, therefore, the manufacturing cost is higher.

The mandrel and the rivet body of a blind rivet of the prior art are unable to fasten the blind rivet into objects to be mounted in various directions during the preassembling step or the installing step. The initial design of the rivet body of a blind rivet of the prior art does not consider that conditions that the mandrels and the rivet body are not pre-fastened on to the objects during the preassembling step or the installing step. As a result, mandrels and rivet bodies of blind rivets of the prior art will simply fall off while being used to fasten objects to be mounted in various directions.

In view of the aforementioned problem, the inventor of the invention investigated the aforementioned deficiency and searched intensively for the solutions thereof based on years of experience of research and development in relevant fields. After a long period of time of research and many experiments, the invention is completed.

### SUMMARY OF THE INVENTION

It is therefore one object of the invention to provide a type of blind rivets with a design of a magnetic washer having a circular arc angle so that, during the construction process for objects to be mounted, the rivet body of the blind rivet can be applied to objects to be mounted in various directions and make the blind rivet secured firmly on to the object to be mounted during the single-sided preassembling step or the installing step through the magnetic washer having a circular arc angle. At the same time, the mandrel of the blind rivet, which has a structural design of a pull section having a reverse pull surface, can effectively reduce the length of the pull section having a reverse pull surface, resulting in the reduction of the overall length of the mandrel. Therefore, the cost of materials can also be reduced.

In order to achieve the aforementioned objective, the improvement features of the mandrel of the invention include that the pull section having a reverse tapered surface of the mandrel of the invention is a conical structure which has a reverse tapered surface angle of 3°-8°, and is configured with a structure of annular grooves having a reverse tapered surface, wherein the annular grooves having a reverse tapered surface can increase the gripping force during the pulling process. Owing to such a design, the length of the pull section having a reverse tapered surface can be reduced while the gripping force of the pull section having a reverse tapered surface of the mandrel remains unchanged. As a result, the overall length of the mandrel is reduced and the production cost is also reduced effectively.

The improvement features of the rivet body of the invention include that the blind rivet, which is paired with the magnetic washer having a circular arc angle, can be used in settings of various directions. The magnetic washer having a circular arc angle of the invention takes the advantage of its own strong magnetism made by production, along with the use of mandrels and rivet bodies with magnetic permeability, to be applied to objects to be mounted that are not horizontal to the gravity direction during the preassembling step and the installing step, and makes the blind rivet secured firmly on to the object to be mounted during steps of the single-sided operations through the magnetic washer having a circular arc angle. The blind rivet of the invention comprises a mandrel, a rivet body, and a magnetic washer having a circular arc angle.

The mandrel of the invention comprises a mandrel head and a shank, wherein the shank comprises a grip section, a groove section, and a pull section having a reverse tapered surface; and the shank diameter is d.

The mandrel head is connected to one side of the grip section of the shank; the end surface of the mandrel head that is connected to one side of the shank has a circular arc surface with a radius of R.

The grip section is the portion of shank close to the mandrel head.

The groove section is disposed on the shank and connected with the grip section; the diameter of the groove section can be d−d/8−d−d/16. The groove section is configured with offset-style radial annular groove portions and an axial line-style slot structure separately. The axial line-style slot structure has four air slots that are 90° apart; the groove depth of the groove section can be d/48−d/32.

The pull section having a reverse tapered surface is disposed on the shank and connected with the groove section; the pull section having a reverse tapered surface is a conical structure, which has a reverse tapered surface angle of 3°-8°, and is configured with a structure of annular grooves having a reverse tapered surface. The annular grooves having a reverse tapered surface can increase the gripping force during the pulling process. Owing to such a design, the length of the pull section having a reverse tapered surface can be reduced while the gripping force of the pull section having a reverse tapered surface of the mandrel remains unchanged. As a result, the overall length of the mandrel is reduced and the production cost is also reduced effectively.

The rivet body of the invention comprises a through hole that can match and be plugged with the mandrel, a rivet head, and a protruding edge structure.

The magnetic washer having a circular arc angle has a through hole that can match and fit onto the mandrel, wherein one side of the washer has a circular arc surface with a radius of R that can engage and join with the circular arc surface with a radius of R of the mandrel head, and can automatically calibrate the deviation, caused by the eccentric force created during the pulling step, through the circular arc surface of radius R thereof.

The construction method of the blind rivets includes the following steps:

The drilling step A of the invention drills a hole of drill aperture d+d/16 in the object to be mounted, a hole slightly larger than the shank of a shank diameter d.

The preassembling step B of the invention is to insert the mandrel from the side of the shank, which faces the side of the circular arc surface of the magnetic washer having a circular arc angle, into the magnetic washer having a circular arc angle, to form the blind rivet of the invention. Next, the preassembled blind rivet is inserted into the pre-drilled hole created from the drilling step.

Due to the use of the magnetic washer having a circular arc angle with strong magnetism made by production, the mandrel with magnetic permeability by production can be attracted and attached on to the object to be mounted through the strong magnetism generated by the magnetic washer having a circular arc angle. Because of the design of the magnetic washer having a circular arc angle, the preassembling step B of the second preferred embodiment of the invention can be a single-sided preassembling step and enhance the accessibility during field operations.

The installing step C of the invention is to insert the rivet body, having the protruding edge structure at the end, into the mandrel after the preassembling step.

Due to the use of the magnetic washer having a circular arc angle with strong magnetism made by production, the mandrel and the rivet body with magnetic permeability by production can be attracted and attached on to the object to be mounted through the strong magnetism generated by the magnetic washer having a circular arc angle. Because of the design of the magnetic washer having a circular arc angle, the preassembling step B of the third preferred embodiment of the invention can preassemble the mandrels and the magnetic washers having a circular arc angle onto the upper side of the object to be mounted through a single-sided operation and then preassemble the rivet bodies to the lower side of the object to be mounted. Through the strong magnetism of the magnetic washer having a circular arc angle, the rivet body is automatically attached on to the object to be mounted and therefore the accessibility during field operations is improved.

The gripping step D of the invention is to place a pull fixture and a pull sleeve onto the pull section having a reverse tapered surface of the mandrel, described in the aforementioned steps, to which the pull fixture and the pull sleeve hold on.

The pulling step E of the invention is to plug and secure the rivet head of the rivet body of the blind rivet into the object to be mounted, which has been drilled with a through hole during the aforementioned drilling step A, by applying force in the axial direction toward the object to be mounted through the pull sleeve. At the same time, the pull fixture is used to grip the pull section having a reverse tapered surface of the mandrel and applies force in the opposite direction of the rivet body, causing strain effects of the rivet head of the rivet body that eventually have the object to be mounted securely fastened.

The advantages of the invention are as follows:

The overall length of the mandrel is reduced and, as a result, the production cost is effectively reduced. The pull section having a reverse tapered surface of the mandrel of the invention is a conical structure which has a reverse tapered surface angle of 3°-8°, and is configured with a structure of annular grooves having a reverse tapered surface, wherein the annular grooves having a reverse tapered surface can increase the gripping force during the pulling process. Owing to such a design, the length of the pull section having a reverse tapered surface can be reduced while the gripping force of the pull section having a reverse tapered surface of the mandrel remains unchanged. As a result, the overall length of the mandrel is reduced and the production cost is also reduced effectively.

The design of the mandrel of the invention has the effect of reducing stress. According to the invention, the groove section of the shank of the mandrel is disposed on the shank and connected with the grip section; the diameter of the groove section can be d−d/8−d−d/16; the groove section is configured with offset-style radial annular groove portions and an axial line-style slot structure separately, wherein the axial line-style slot structure has four air slots that are 90° apart and the groove depth of the groove section can be d/48−d/32. Through the axial line-style slot structure having four air slots that are 90° apart, the mandrel of the invention has the effect of reducing stress.

The blind rivet, which is paired with the magnetic washer having a circular arc angle, can be used in settings of various directions. The magnetic washer having a circular arc angle of the invention takes the advantage of its own strong magnetism made by production, along with the use of mandrels and rivet bodies with magnetic permeability, to be applied to objects to be mounted that are not horizontal to the gravity direction during the preassembling step B and the installing step C. The blind rivet is secured firmly on to the object to be mounted during steps of the single-sided operations through the magnetic washer having a circular arc angle.

The above and other objects, features and advantages of the invention will become apparent from the following detailed description taken with the accompanying drawings

### BRIEF DESCRIPTION OF THE DRAWINGS

FIG. 1 is a perspective exploded view of the blind rivet of the invention;

FIG. 2 is an exploded view of the front view of the blind rivet of the invention;

FIG. 3 is a composite view of the front and sectional view of the blind rivet of the invention;

FIG. 4 is a schematic view of the drilling step A of the invention;

FIG. 5 is a schematic view of the preassembling step B of the first preferred embodiment of the invention;

FIG. 6 is a schematic view of the installing step C of the first preferred embodiment of the invention;

FIG. 7 is a schematic view of the gripping step D of the first preferred embodiment of the invention;

FIG. 8 is a schematic view of the gripping step D of the first preferred embodiment of the invention;

FIG. 9 is a schematic view of the pulling step E of the first preferred embodiment of the invention;

FIG. 10 is a schematic view of the pulling step E of the first preferred embodiment of the invention;

FIG. 11 is a schematic view upon completion of the pulling step of the first preferred embodiment of the invention;

FIG. 12 is a schematic view of the preassembling step B of the second preferred embodiment of the invention;

FIG. 13 is a schematic view of the preassembling step B of the second preferred embodiment of the invention;

FIG. 14 is a schematic view of the installing step C of the second preferred embodiment of the invention;

FIG. 15 is a schematic view of the gripping step D of the second preferred embodiment of the invention;

FIG. 16 is a schematic view of the gripping step D of the second preferred embodiment of the invention;

FIG. 17 is a schematic view of the pulling step E of the second preferred embodiment of the invention;

FIG. 18 is a schematic view of the pulling step E of the second preferred embodiment of the invention;

FIG. 19 is a schematic view upon completion of the pulling step E of the second preferred embodiment of the invention;

FIG. 20 is a schematic view of the preassembling step B of the third preferred embodiment of the invention;

FIG. 21 is a schematic view of the installing step C of the third preferred embodiment of the invention;

FIG. 22 is a schematic view of the gripping step D of the third preferred embodiment of the invention;

FIG. 23 is a schematic view of the gripping step D of the third preferred embodiment of the invention;

FIG. 24 is a schematic view of the pulling step E of the third preferred embodiment of the invention;

FIG. 25 is a schematic view of the pulling step E of the third preferred embodiment of the invention;

FIG. 26 is a schematic view upon completion of the pulling step of the third preferred embodiment of the invention; and

FIG. 27 is a schematic view upon completion of the pulling step of the first, second, and third preferred embodiments of the invention.

### DETAILED DESCRIPTION OF THE INVENTION

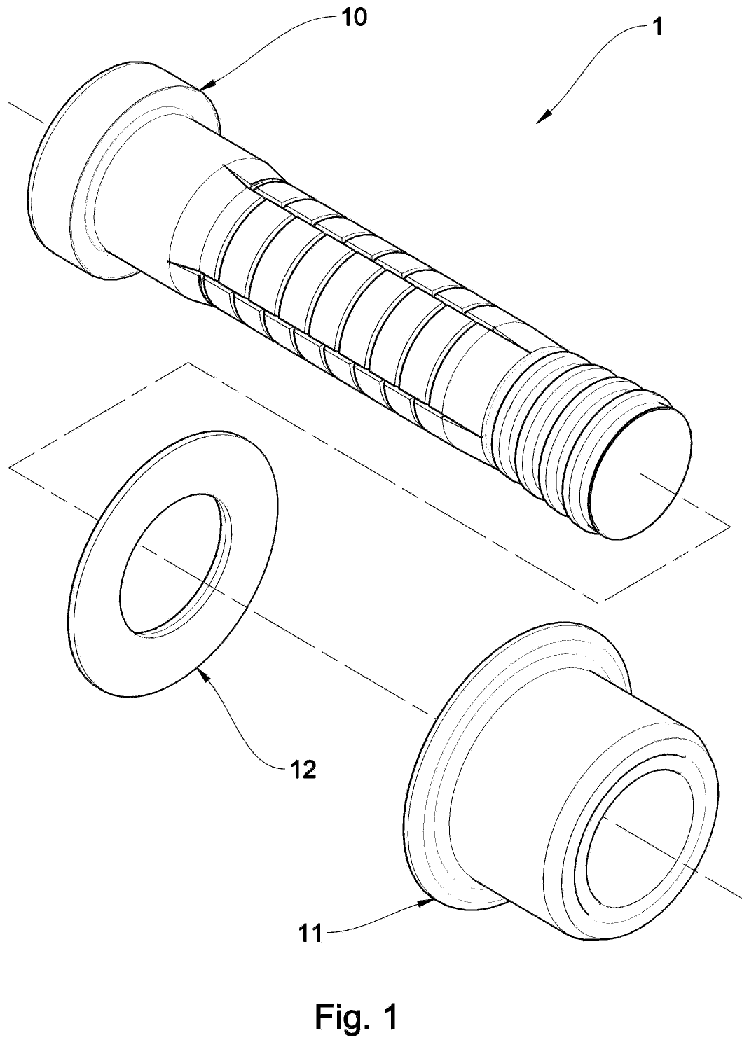

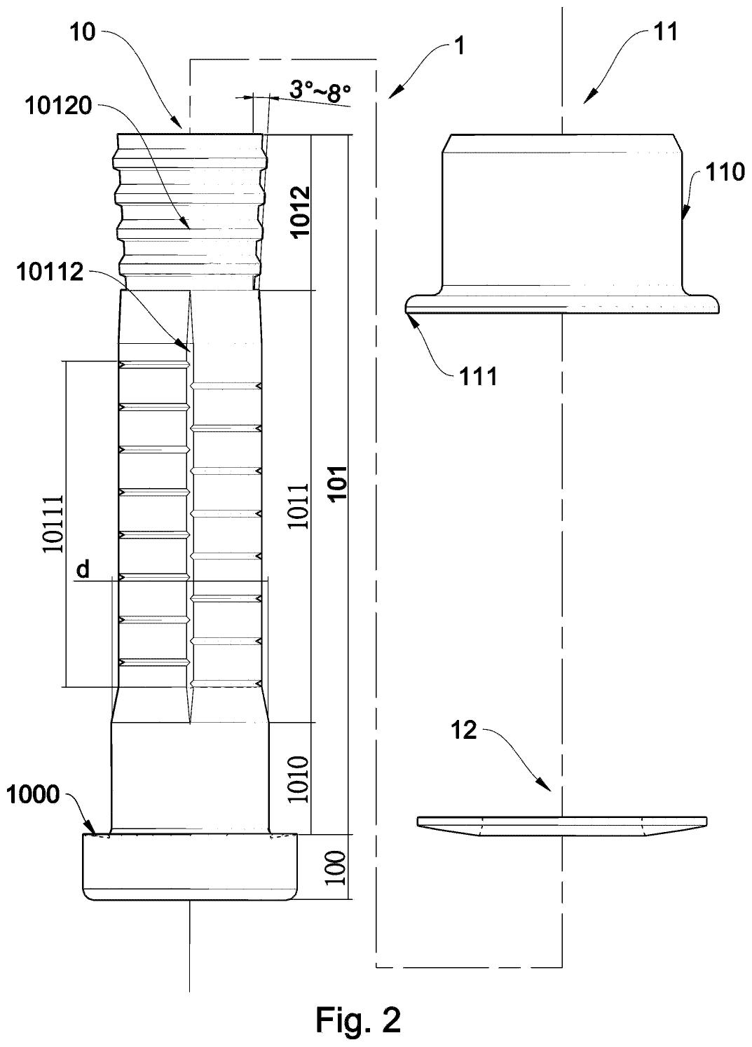

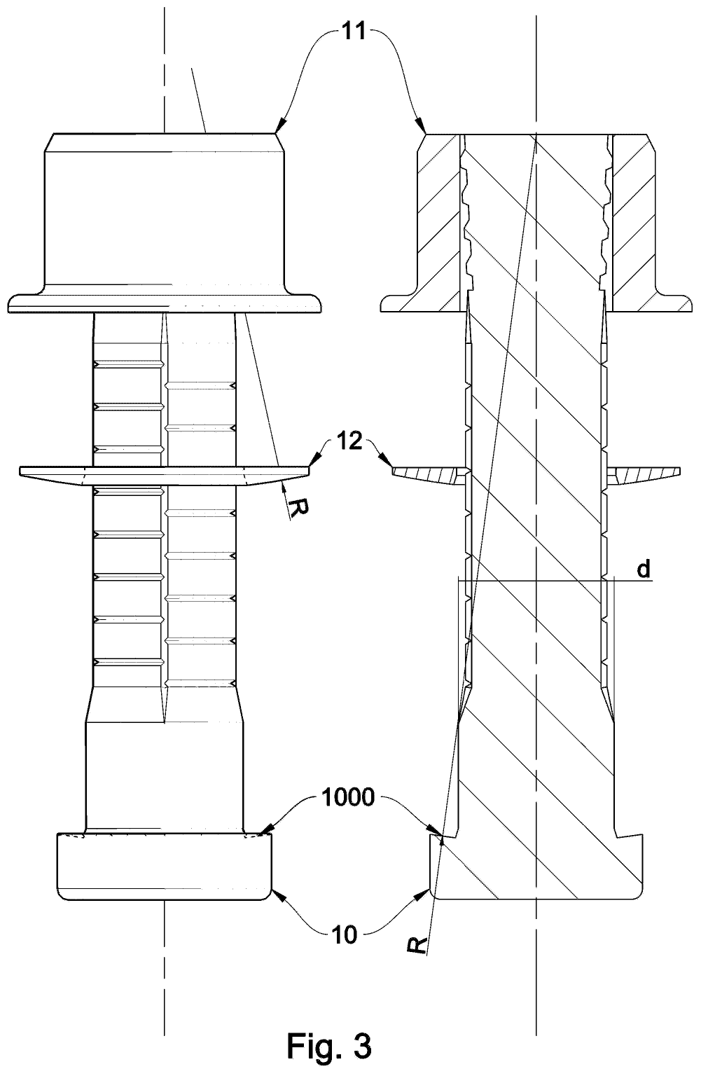

Please refer to FIG. 1, FIG. 2, and FIG. 3. FIG. 1 is a perspective exploded view of the blind rivet 1 of the invention; FIG. 2 is an exploded view of the front view of the blind rivet 1 of the invention; and FIG. 3 is a composite view of the front and sectional view of the blind rivet 1 of the invention.

As shown in FIG. 1, the invention relates to a type of blind rivet 1, comprising a mandrel 10, a rivet body 11, and a magnetic washer having a circular arc angle 12.

As shown in FIG. 2, the mandrel 10 of the invention comprises a mandrel head 100 and a shank 101, wherein the shank 101 comprises a grip section 1010, a groove section 1011, and a pull section having a reverse tapered surface 1012; and the shank diameter is d.

The mandrel head 100 is connected to one side of the grip section 1010 of the shank 101; the end surface of the mandrel head 100 that is connected with one side of the shank 101 has a circular arc surface with a radius of R.

The grip section 1010 is the portion of shank 101 close to the mandrel head 100. The groove section 1011 is disposed on the shank 101 and connected with the grip section 1010; the diameter of the groove section 1011 can be d−d/8−d−d/16. The groove section 1011 is configured with offset-style radial annular groove portions 10111 and an axial line-style slot structure 10112 separately. The axial line-style slot structure 10112 has four air slots that are 90° apart; the groove depth of the groove section can be d/48−d/32.

The pull section has a reverse tapered surface 1012 which is disposed on the shank 101 and connected with the groove section 1011; the pull section having a reverse tapered surface 1012 is a conical structure, which has a reverse tapered surface angle of 3°-8°, and is configured with a structure of annular grooves having a reverse tapered surface 10120. The annular grooves having a reverse tapered surface 10120 can increase the gripping force during the pulling process. Owing to such a design, the length of the pull section having a reverse tapered surface 1012 can be reduced while the gripping force of the pull section having a reverse tapered surface 1012 of the mandrel 10 remains unchanged. As a result, the overall length of the mandrel 10 is reduced and the production cost is also reduced effectively.

As shown in FIG. 2 and FIG. 3, the rivet body 11 of the invention comprises a through hole that can match and be plugged with the mandrel, a rivet head 110, and a protruding edge structure 111.

As shown in FIG. 2 and FIG. 3, the magnetic washer having a circular arc angle 12 has a through hole that can match and fit onto the mandrel, wherein one side of the washer has a circular arc surface with a radius of R that can engage and join with the circular arc surface with a radius of R of the mandrel head 100, and can automatically calibrate the deviation, caused by the eccentric force created during the pulling step, through the circular arc surface of radius R thereof.

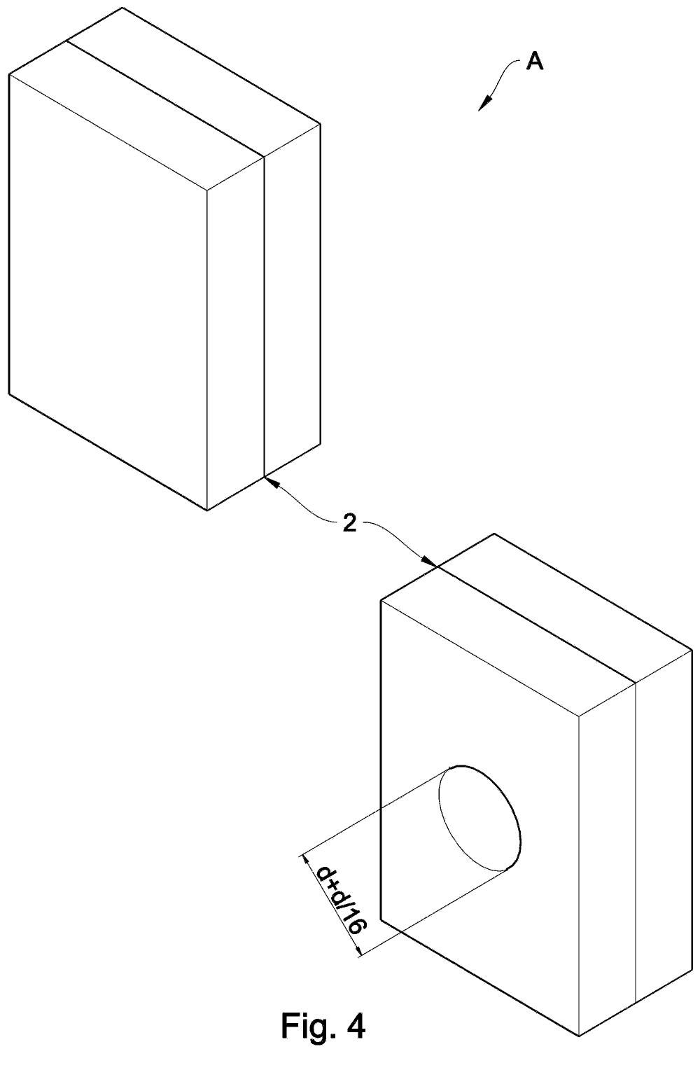

Please refer to FIG. 4. FIG. 4 is a schematic view of the drilling step A of the invention. As shown in FIG. 4, the drilling step A of the invention drills a hole of drill aperture d+d/16 in the object to be mounted 2, a hole slightly larger than the shank 101 of a shank diameter d.

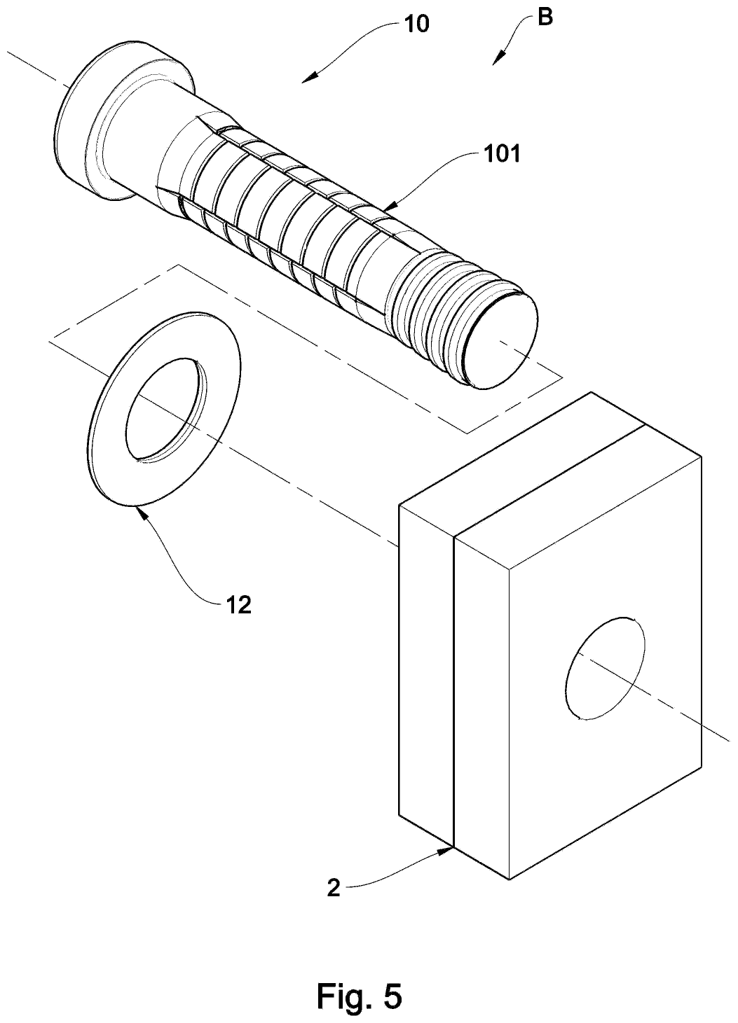

Please refer to FIG. 5. FIG. 5 is a schematic view of the preassembling step B of the first preferred embodiment of the invention. As shown in FIG. 5, the preassembling step B of the first preferred embodiment of the invention is to insert the mandrel 10 from the side of the shank 101, which faces the side of the circular arc surface of the magnetic washer having a circular arc angle 12, into the magnetic washer having a circular arc angle 12, to form the blind rivet 1 of the invention. Next, the preassembled blind rivet 1 is inserted into the pre-drilled hole of the object to be mounted 2 created from the drilling step A.

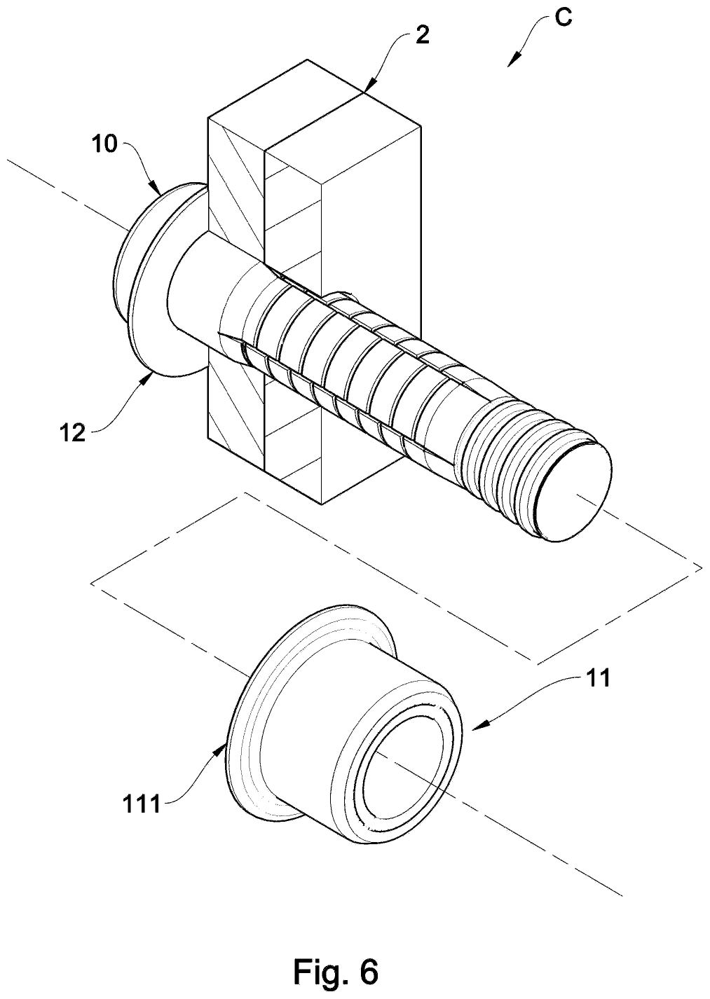

Please refer to FIG. 6. FIG. 6 is a schematic view of the installing step C of the first preferred embodiment of the invention. As shown in FIG. 6, the installing step C of the first preferred embodiment of the invention is to insert the rivet body 11, having the protruding edge structure 111 at the end, into the mandrel 10 after the preassembling step.

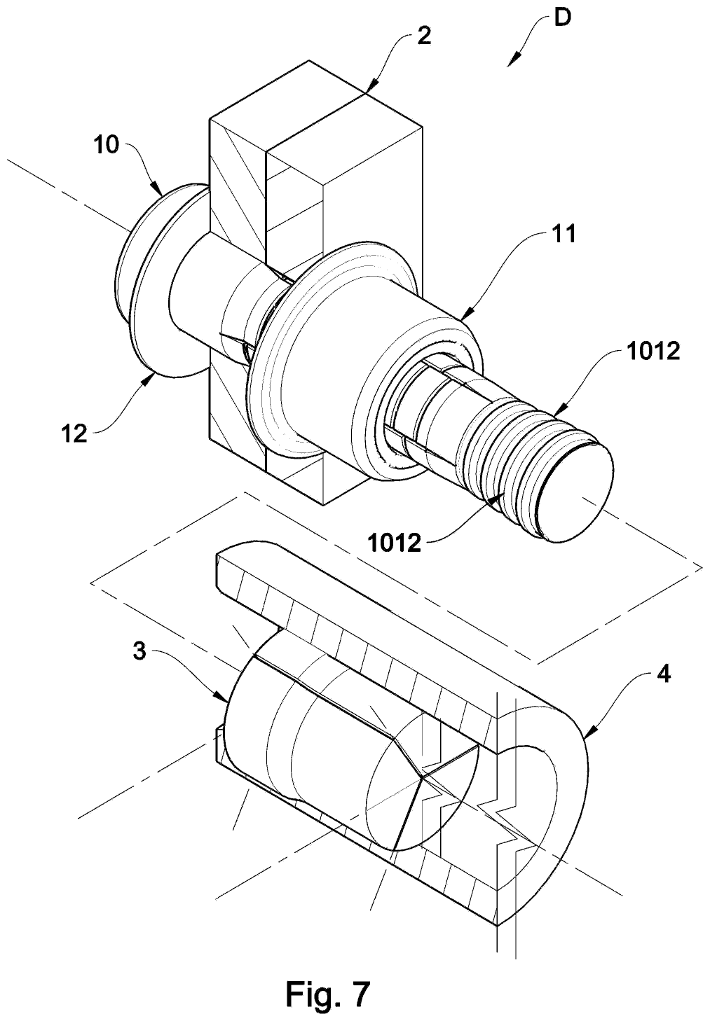

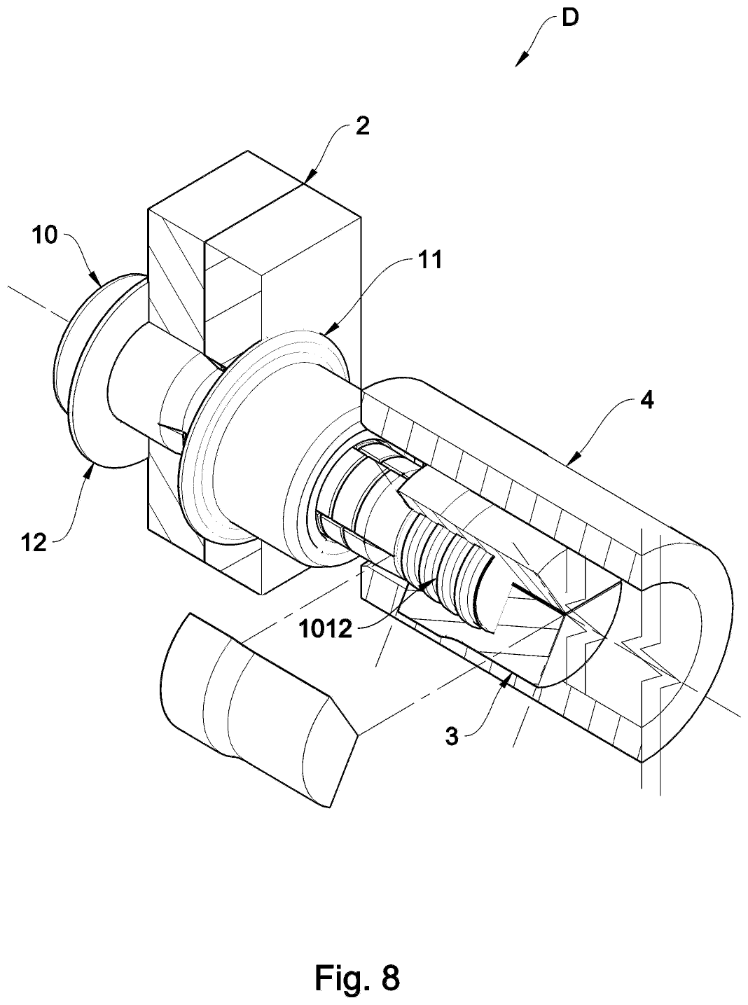

Please refer to FIG. 7 and FIG. 8. Both FIG. 7 and FIG. 8 are a schematic view of the gripping step D of the first preferred embodiment of the invention separately. As shown in FIG. 7 and FIG. 8, the gripping step D of the first preferred embodiment of the invention is to place a pull fixture 3 and a pull sleeve 4 onto the pull section having a reverse tapered surface 1012 of the mandrel 10, described in the aforementioned installing step, to which the pull fixture 3 and the pull sleeve 4 hold on.

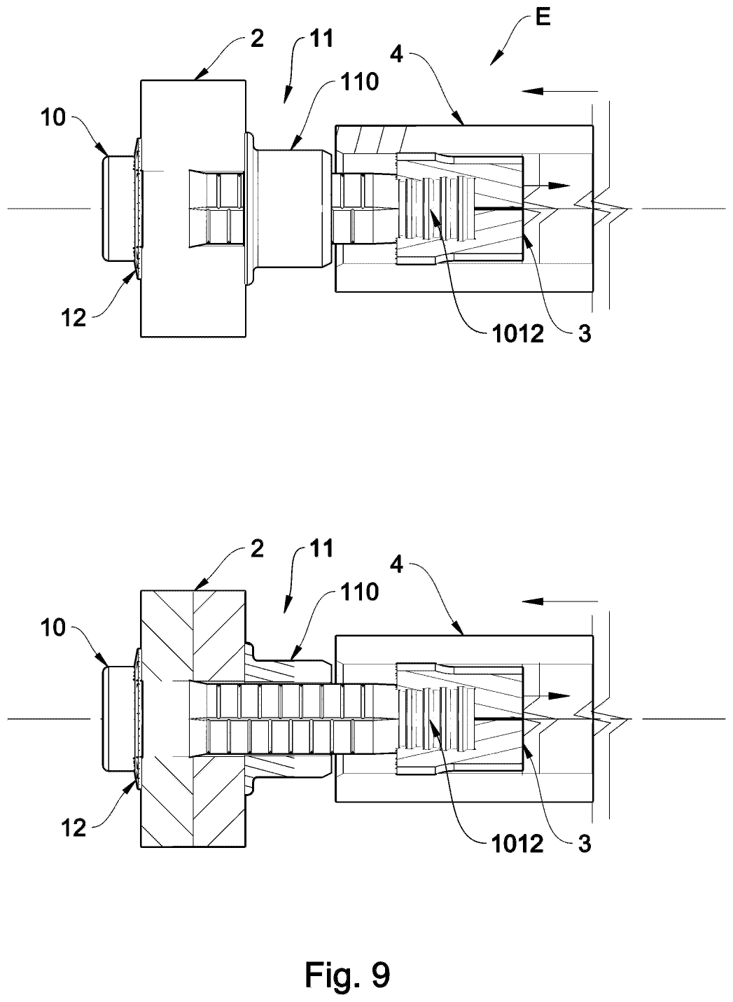

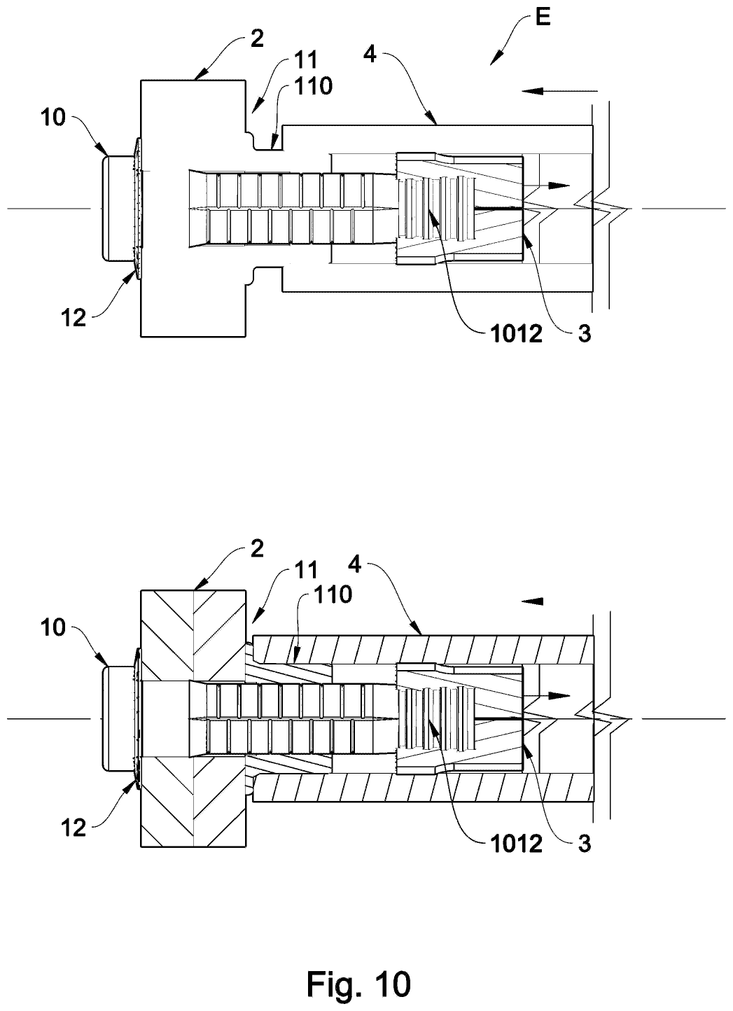

Please refer to FIG. 9 and FIG. 10. Both FIG. 9 and FIG. 10 are a schematic view of the pulling step E of the first preferred embodiment of the invention separately. A shown in FIG. 9 and FIG. 10, the pulling step E of the first preferred embodiment of the invention is to plug and secure the rivet head 110 of the rivet body 11 of the blind rivet 1 into the object to be mounted, which has been drilled with a through hole during the aforementioned drilling step A, by applying force in the axial direction toward the object to be mounted through the pull sleeve 4. At the same time, the pull fixture 3 is used to grip the pull section having a reverse tapered surface 1012 of the mandrel and applies force in the opposite direction of the rivet body 11, causing strain effects of the rivet head 110 of the rivet body 11 that eventually have the object to be mounted 2 securely fastened.

A fixture of a blind rivet, comprising a pull fixture and a pull sleeve, wherein the pull fixture comprises a set of 3-segment assembled parts, having an annular protruding edge structure on the inner surface thereof that can grip the pull section of the mandrel; and the pull sleeve has a hollow sleeve structure and the pull fixture can be placed within the hollow sleeve structure of the pull sleeve; the pull sleeve is used in the pulling step E to apply force that causes strain effects of the rivet body making the object to be mounted securely fastened.

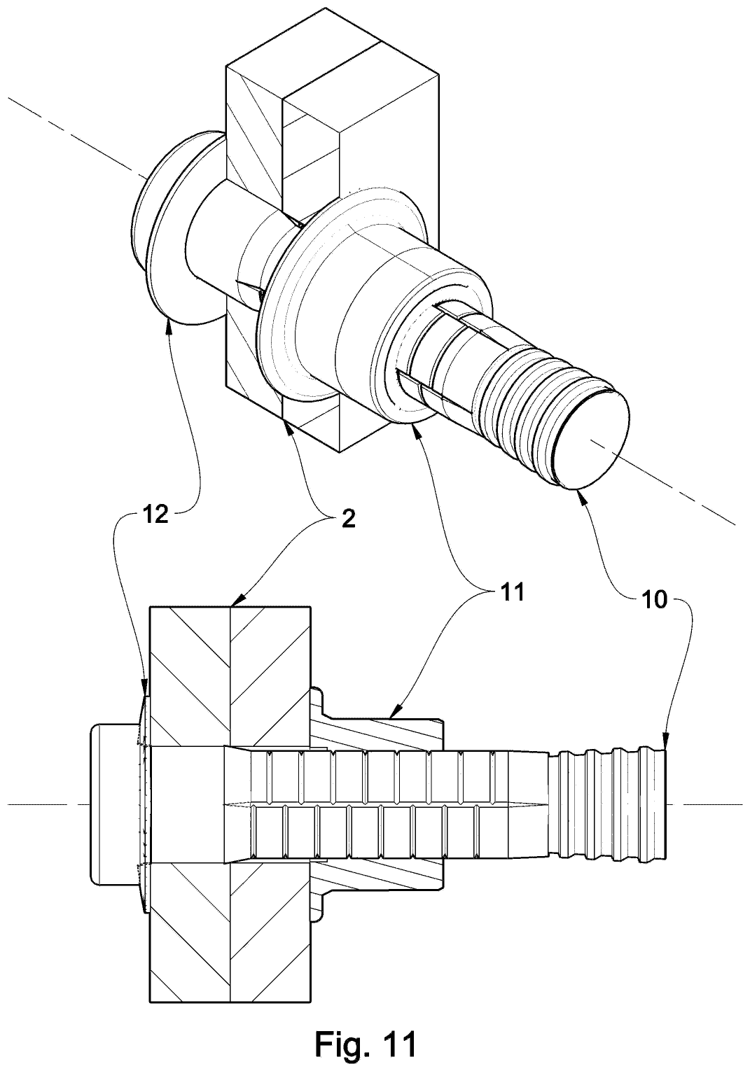

Please refer to FIG. 11. FIG. 11 is a schematic view upon completion of the pulling step E of the first preferred embodiment of the invention. As shown in FIG. 11, the blind rivet 1 of the first preferred embodiment of the invention can be applied in securing objects to be mounted 2. According to FIG. 11, the blind rivet 1 of the invention is a locking method for a permanent joint.

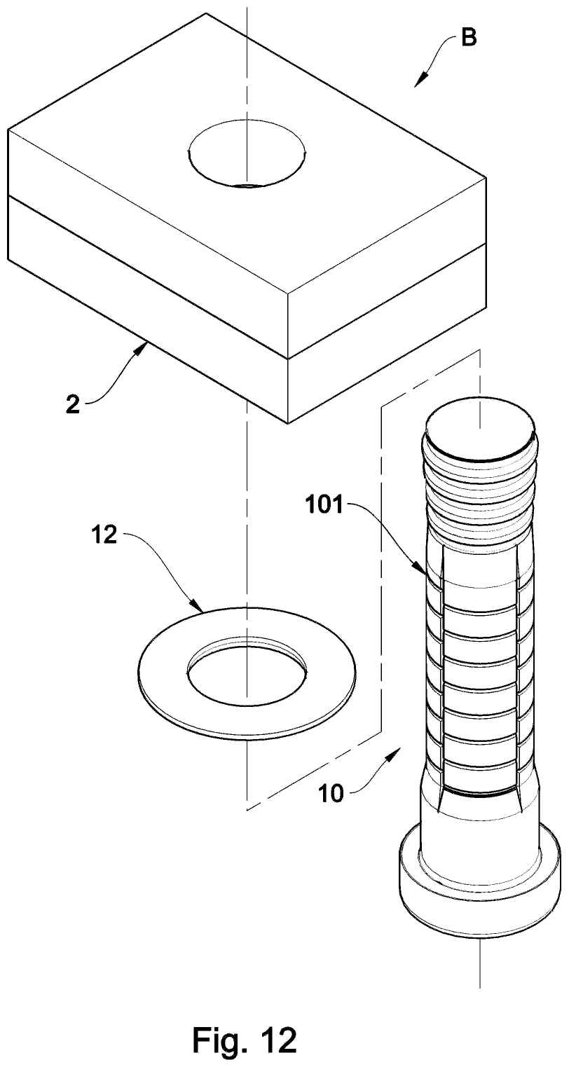

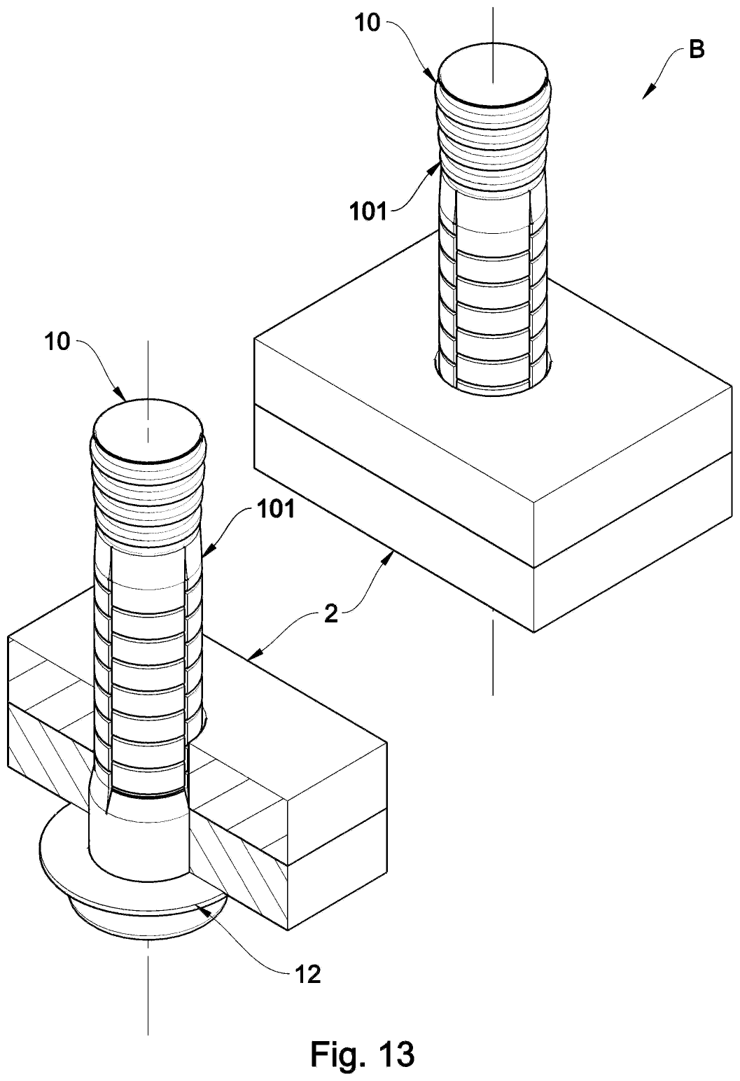

Please refer to FIG. 12 and FIG. 13. Both FIG. 12 and FIG. 13 are a schematic view of the preassembling step B of the second preferred embodiment of the invention separately. As shown in FIG. 12 and FIG. 13, the preassembling step B of the second preferred embodiment of the invention is to vertically and upwardly insert the mandrel 10 from the side of the shank 101, which faces the side of the circular arc surface of the magnetic washer having a circular arc angle 12, into the magnetic washer having a circular arc angle 12, to form the blind rivet 1 of the invention. Next, the preassembled blind rivet 1 is inserted vertically and upwardly into the pre-drilled hole of the object to be mounted 2 created from the drilling step A. Due to the use of the magnetic washer having a circular arc angle 12 with strong magnetism made by production, the mandrel 10 with magnetic permeability by production can be attracted and attached on to the object to be mounted 2 through the strong magnetism generated by the magnetic washer having a circular arc angle 12. Because of the design of the magnetic washer having a circular arc angle 12, the preassembling step B of the second preferred embodiment of the invention can be a single-sided preassembling step and enhance the accessibility during field operations.

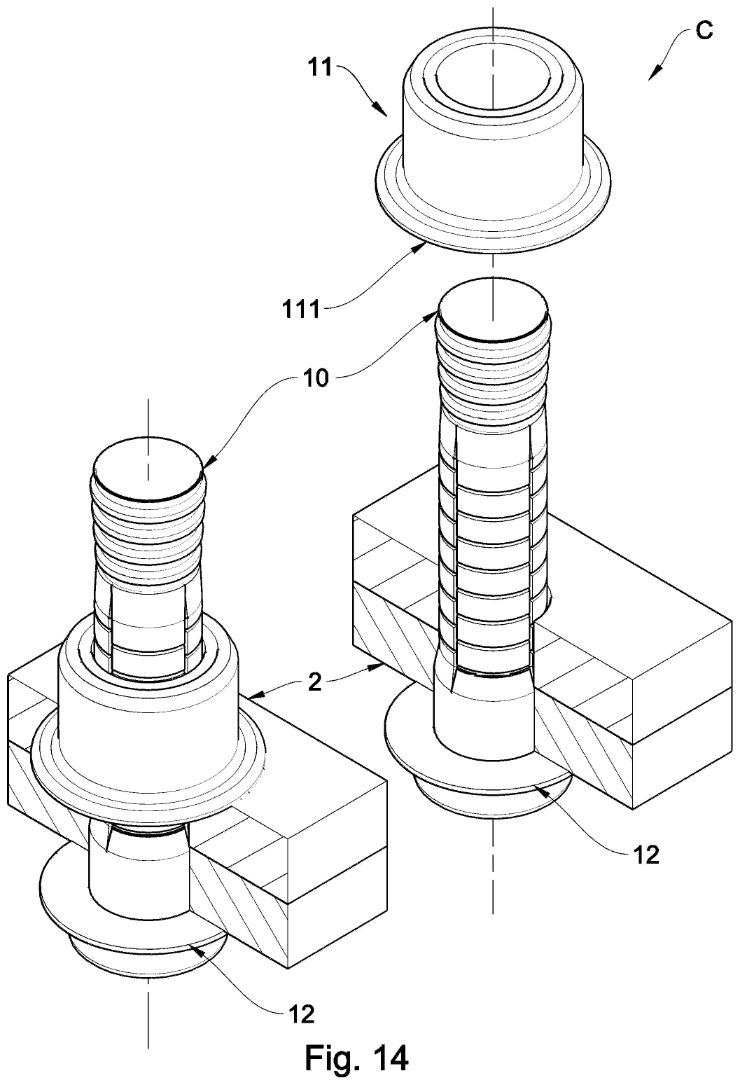

Please refer to FIG. 14. FIG. 14 is a schematic view of the installing step C of the second preferred embodiment of the invention. As shown in FIG. 14, the installing step C of the second preferred embodiment of the invention is to insert the rivet body 11, having the protruding edge structure 111 at the end, into the mandrel 10 after the preassembling step.

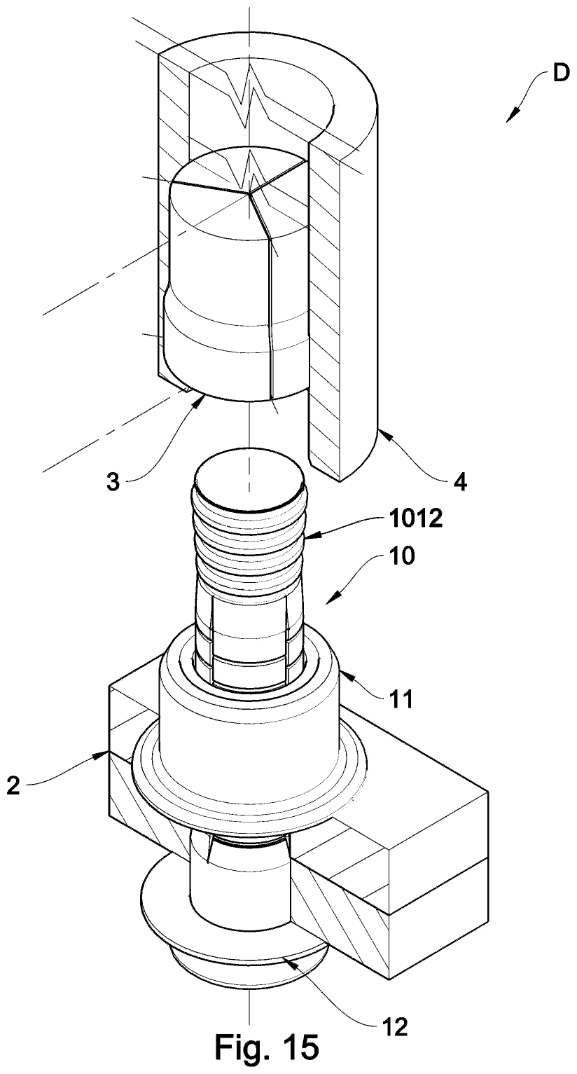

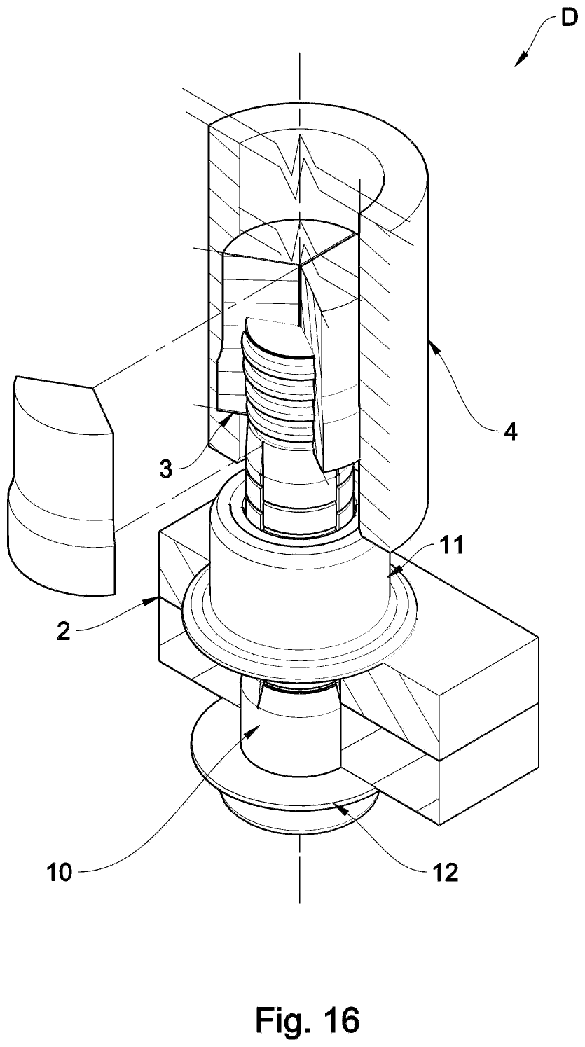

Please refer to FIG. 15 and FIG. 16. Both FIG. 15 and FIG. 16 are a schematic view of the gripping step D of the second preferred embodiment of the invention separately. As shown in FIG. 15 and FIG. 16, the gripping step D of the second preferred embodiment of the invention is to place a pull fixture 3 and a pull sleeve 4 onto the pull section having a reverse tapered surface 1012 of the mandrel 10, described in the aforementioned installing step, to which the pull fixture 3 and the pull sleeve 4 hold on.

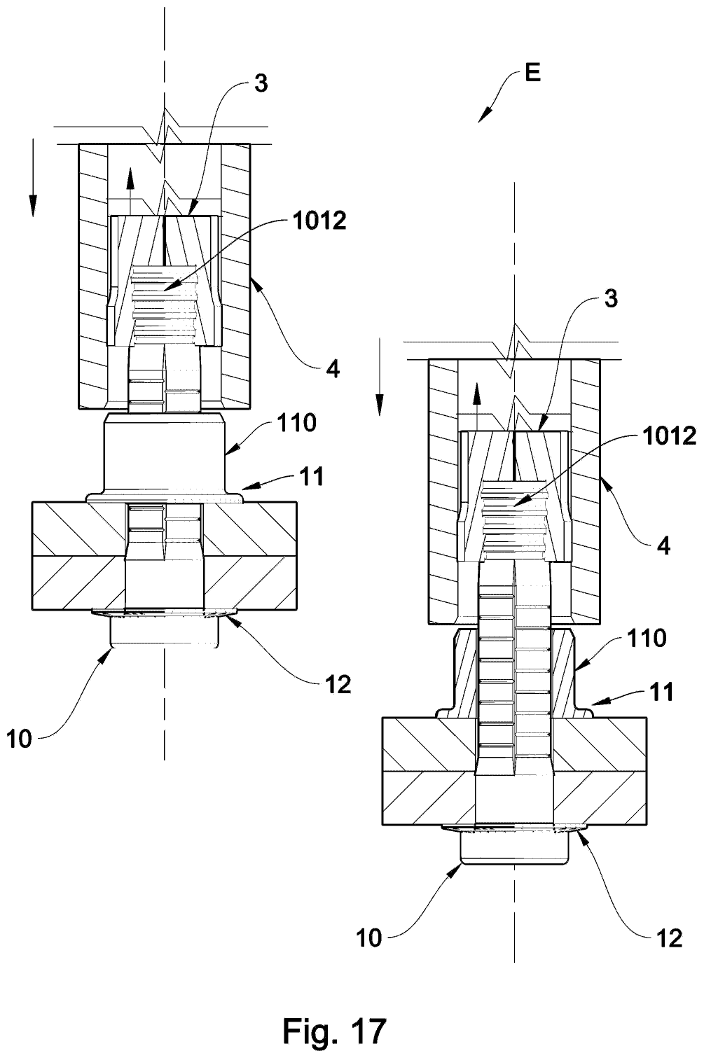

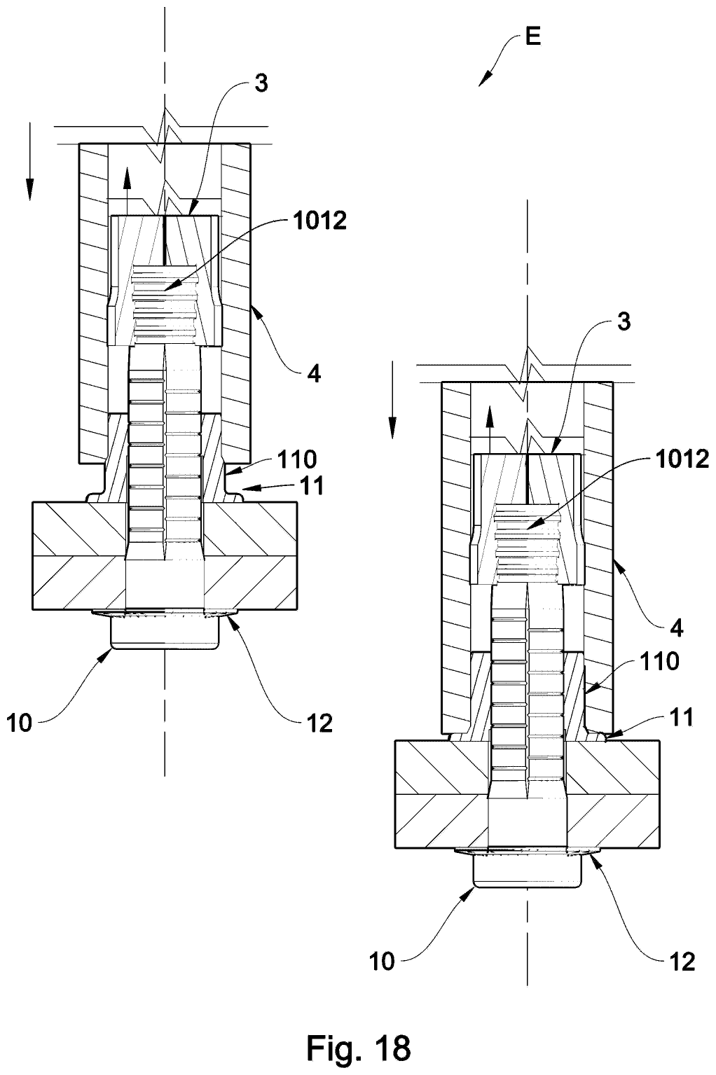

Please refer to FIG. 17 and FIG. 18. Both FIG. 17 and FIG. 18 are a schematic view of the pulling step E of the second preferred embodiment of the invention separately. As shown in FIG. 17 and FIG. 18, the pulling step E of the second preferred embodiment of the invention is to plug and secure the rivet head 110 of the rivet body 11 of the blind rivet 1 into the object to be mounted, which has been drilled with a through hole during the aforementioned drilling step A, by applying force in the axial direction toward the object to be mounted through the pull sleeve 4. At the same time, the pull fixture 3 is used to grip the pull section having a reverse tapered surface 1012 of the mandrel and applies force in the opposite direction of the rivet body 11, causing strain effects of the rivet head 110 of the rivet body 11 that eventually have the object to be mounted 2 securely fastened.

A fixture of a blind rivet, comprising a pull fixture and a pull sleeve, wherein the pull fixture comprises a set of 3-segment assembled parts, having an annular protruding edge structure on the inner surface thereof that can grip the pull section of the mandrel; and the pull sleeve has a hollow sleeve structure and the pull fixture can be placed within the hollow sleeve structure of the pull sleeve; the pull sleeve is used in the pulling step E to apply force that causes strain effects of the rivet body making the object to be mounted securely fastened.

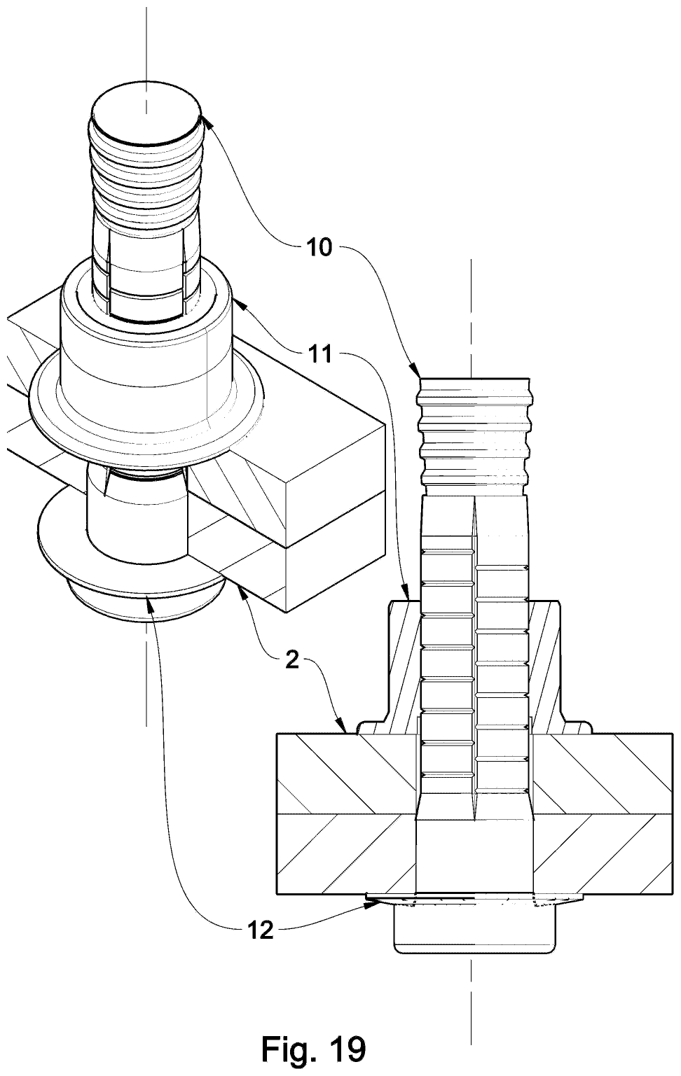

Please refer to FIG. 19. FIG. 19 is a schematic view upon completion of the pulling step E of the second preferred embodiment of the invention. As shown in FIG. 19, the blind rivet 1 of the second preferred embodiment of the invention can be applied in securing objects to be mounted 2. According to FIG. 19, the blind rivet 1 of the invention is a locking method for a permanent joint.

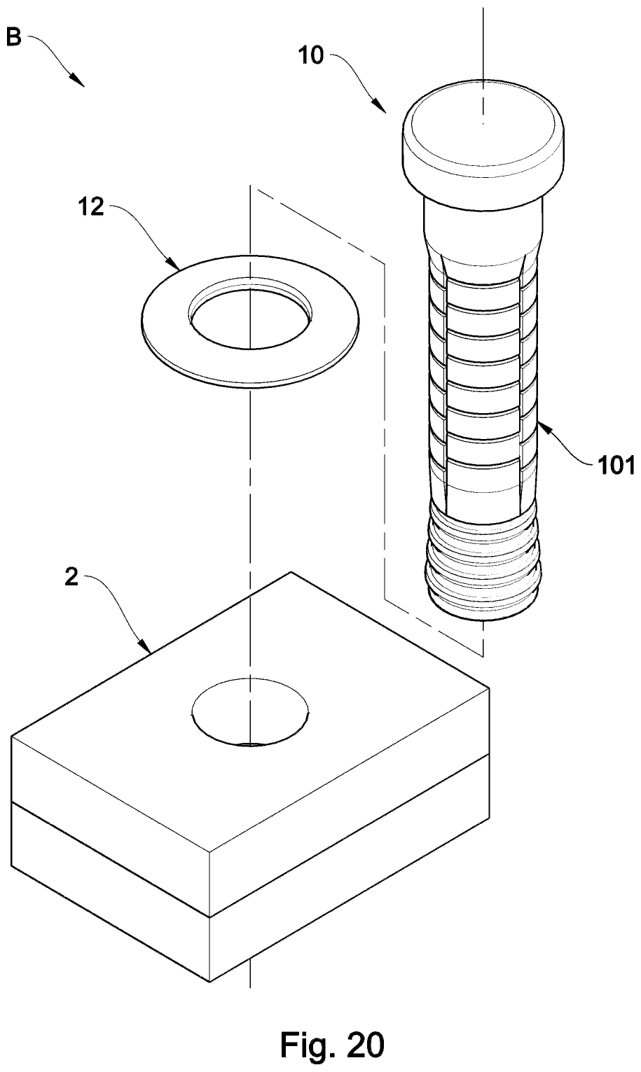

Please refer to FIG. 20. FIG. 20 is a schematic view of the preassembling step B of the third preferred embodiment of the invention. As shown in FIG. 20, the preassembling step B of the third preferred embodiment of the invention is to vertically and downwardly insert the mandrel 10 from the side of the shank 101, which faces the side of the circular arc surface of the magnetic washer having a circular arc angle 12, into the magnetic washer having a circular arc angle 12, to form the blind rivet 1 of the invention. Next, the preassembled blind rivet 1 is inserted vertically and downwardly into the pre-drilled hole of the object to be mounted 2 created from the drilling step A.

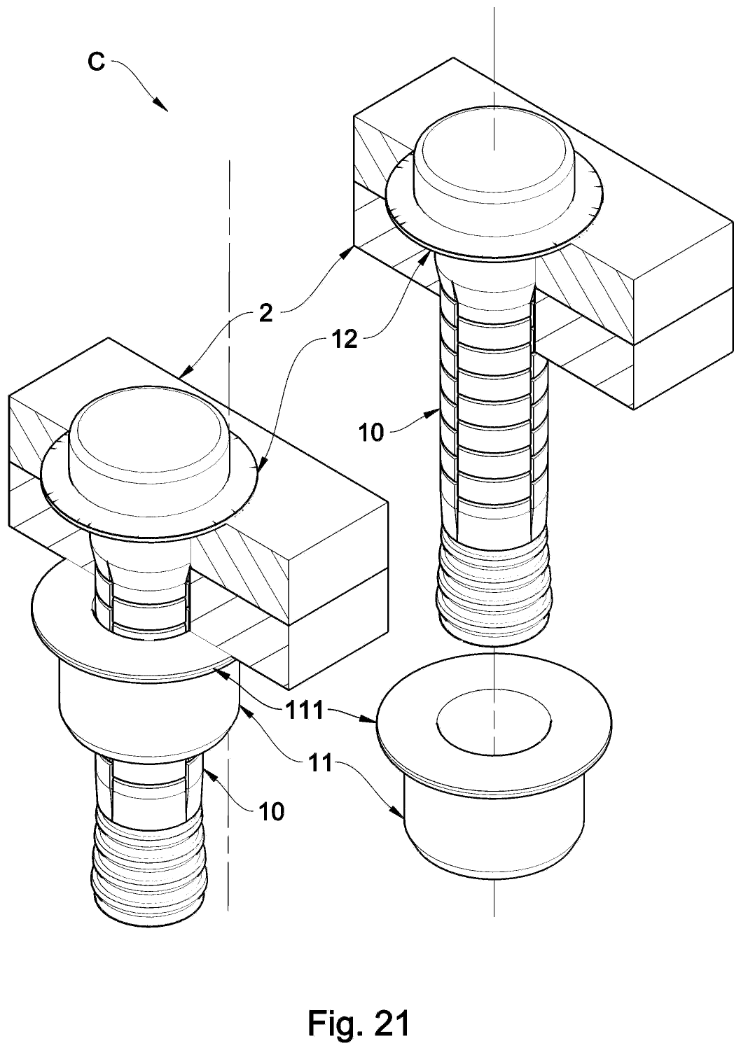

Please refer to FIG. 21. FIG. 21 is a schematic view of the installing step C of the third preferred embodiment of the invention. As shown in FIG. 21, the installing step C of the third preferred embodiment of the invention is to insert the rivet body 11, having the protruding edge structure 111 at the end, into the mandrel 10 after the preassembling step. Due to the use of the magnetic washer having a circular arc angle 12 with strong magnetism made by production, the mandrel 10 and the rivet body 11 with magnetic permeability by production can be attracted and attached on to the object to be mounted 2 through the strong magnetism generated by the magnetic washer having a circular arc angle 12. Because of the design of the magnetic washer having a circular arc angle 12, the preassembling step B of the third preferred embodiment of the invention can preassemble the mandrels 10 and the magnetic washers having a circular arc angle 12 onto the upper side of the object to be mounted 2 through a single-sided operation and then preassemble the rivet bodies 11 to the lower side of the object to be mounted 2. Through the strong magnetism of the magnetic washer having a circular arc angle 12, the rivet body 11 is automatically attached on to the object to be mounted 2 and therefore the accessibility during field operations is improved.

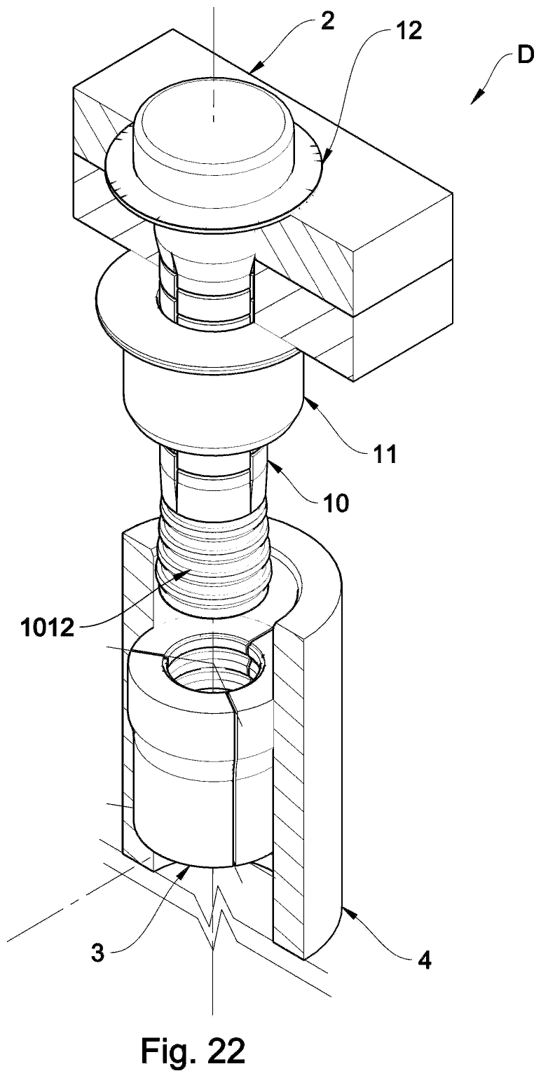

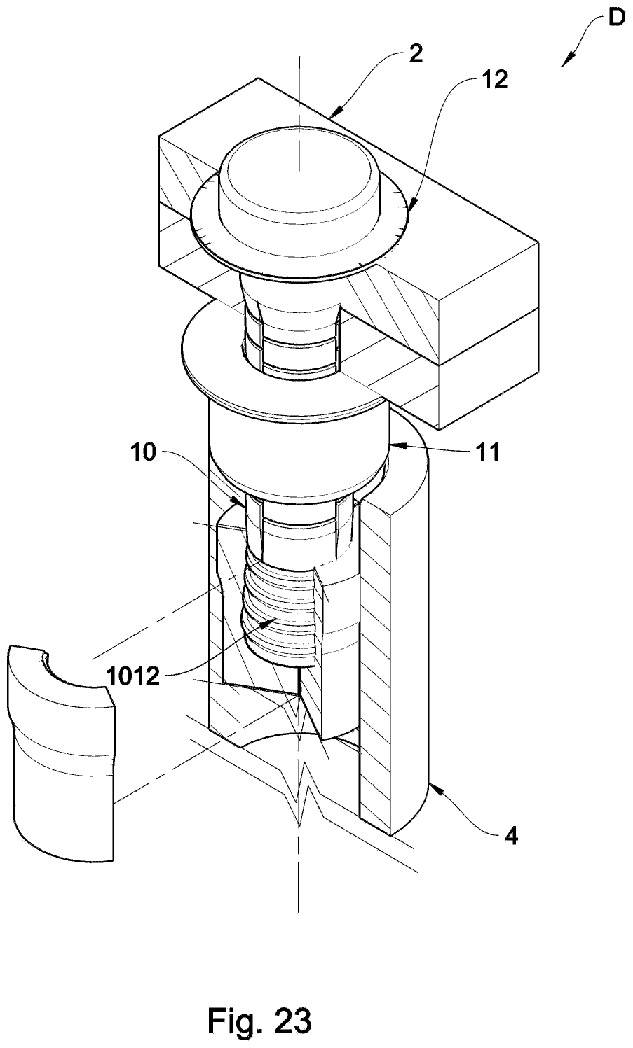

Please refer to FIG. 22 and FIG. 23. Both FIG. 22 and FIG. 23 are a schematic view of the gripping step D of the third preferred embodiment of the invention separately. As shown in FIG. 22 and FIG. 23, the gripping step D of the third preferred embodiment of the invention is to place a pull fixture 3 and a pull sleeve 4 onto the pull section having a reverse tapered surface 1012 of the mandrel 10, described in the aforementioned installing step, to which the pull fixture 3 and the pull sleeve 4 hold on.

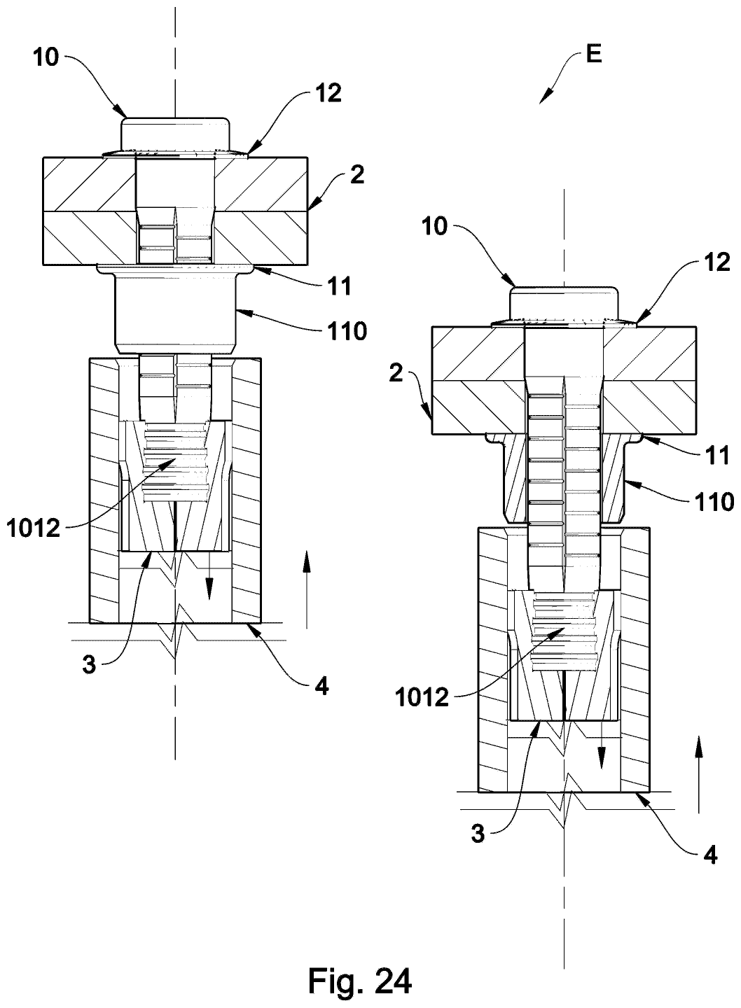

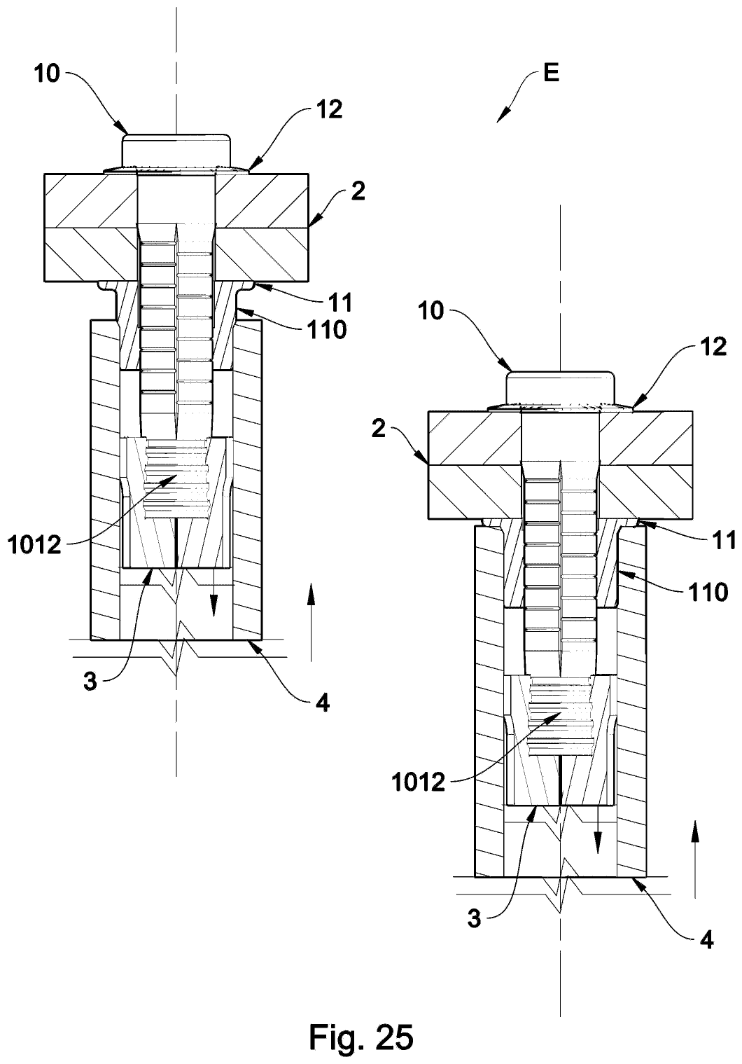

Please refer to FIG. 24 and FIG. 25. Both FIG. 24 and FIG. 25 are a schematic view of the pulling step E of the third preferred embodiment of the invention. As shown in FIG. 24 and FIG. 25, the pulling step E of the third preferred embodiment of the invention is to plug and secure the rivet head 110 of the rivet body 11 of the blind rivet 1 into the object to be mounted, which has been drilled with a through hole during the aforementioned drilling step A, by applying force in the axial direction toward the object to be mounted through the pull sleeve 4. At the same time, the pull fixture 3 is used to grip the pull section having a reverse tapered surface 1012 of the mandrel and applies force in the opposite direction of the rivet body 11, causing strain effects of the rivet head 110 of the rivet body 11 that eventually have the object to be mounted 2 securely fastened.

A fixture of a blind rivet, comprising a pull fixture and a pull sleeve, wherein the pull fixture comprises a set of 3-segment assembled parts, having an annular protruding edge structure on the inner surface thereof that can grip the pull section of the mandrel; and the pull sleeve has a hollow sleeve structure and the pull fixture can be placed within the hollow sleeve structure of the pull sleeve; the pull sleeve is used in the pulling step E to apply force that causes strain effects of the rivet body making the object to be mounted securely fastened.

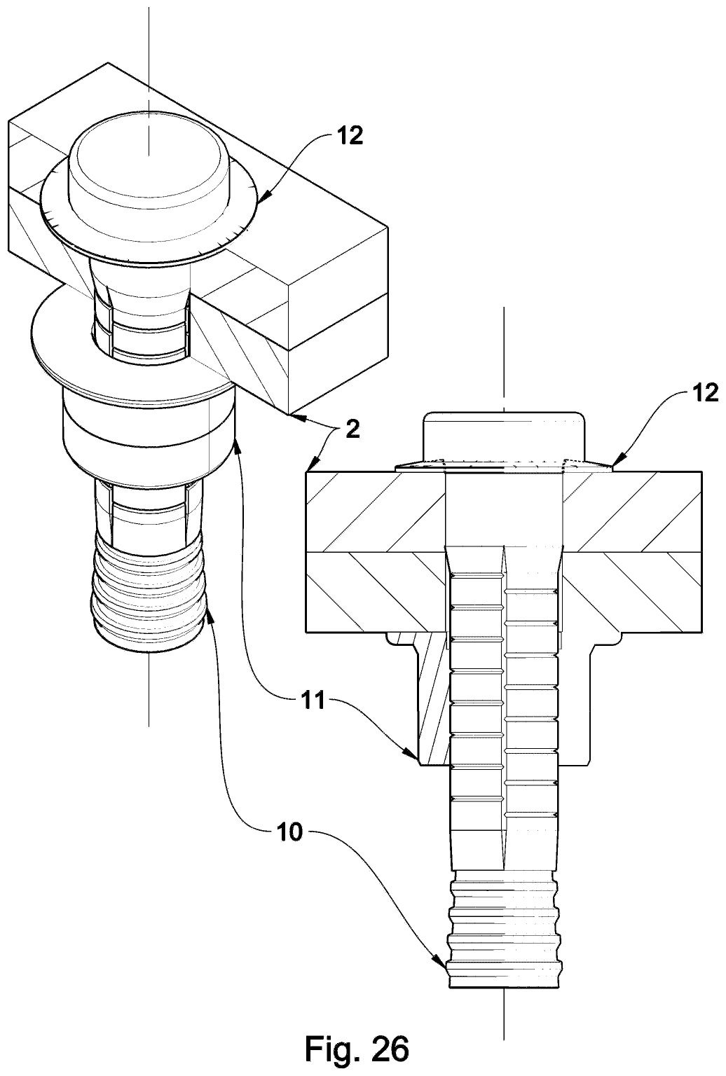

Please refer to FIG. 26. FIG. 26 is a schematic view upon completion of the pulling step of the third preferred embodiment of the invention. As shown in FIG. 26, the blind rivet 1 of the third preferred embodiment of the invention can be applied in securing objects to be mounted 2. According to FIG. 26, the blind rivet 1 of the invention is a locking method for a permanent joint.

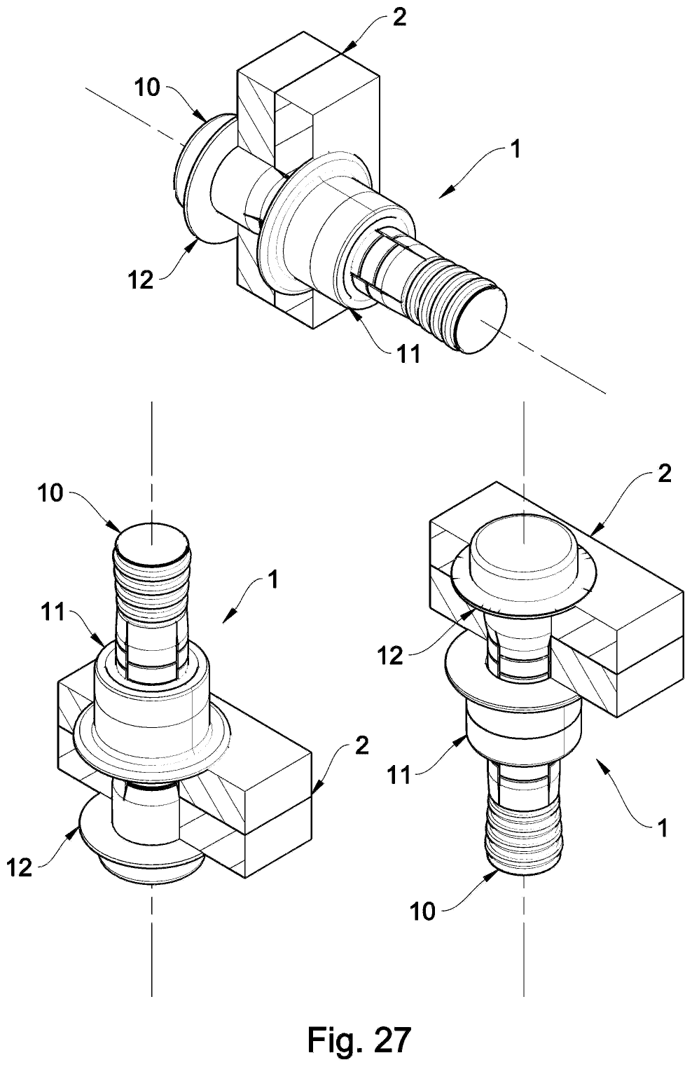

Please refer to FIG. 27. FIG. 27 is a schematic view upon completion of the pulling step of the first, second, and third preferred embodiments of the invention. As shown in FIG. 27, the blind rivet 1 of the first, second, and third preferred embodiments of the invention can be applied in securing objects to be mounted 2. According to FIG. 27, the blind rivet 1 of the invention is a locking method for a permanent joint.

The advantages of the invention are as follows:

The overall length of the mandrel is reduced and, as a result, the production cost is effectively reduced. The pull section having a reverse tapered surface 1012 of the mandrel 10 of the invention is a conical structure which has a reverse tapered surface angle of 3°-8°, and is configured with a structure of annular grooves having a reverse tapered surface 10120, wherein the annular grooves having a reverse tapered surface 10120 can increase the gripping force during the pulling process. Owing to such a design, the length of the pull section having a reverse tapered surface 1012 can be reduced while the gripping force of the pull section having a reverse tapered surface 1012 of the mandrel 10 remains unchanged. As a result, the overall length of the mandrel 10 is reduced and the production cost is also reduced effectively.

The design of the mandrel of the invention has the effect of reducing stress. According to the invention, the groove section 1011 of the shank 101 of the mandrel 10 is disposed on the shank 101 and connected with the grip section 1010; the diameter of the groove section 1011 can be d−d/8−d−d/16; the groove section 1011 is configured with offset-style radial annular groove portions 10111 and an axial line-style slot structure 10112 separately, wherein the axial line-style slot structure 10112 has four air slots that are 90° apart and the groove depth of the groove section 1011 can be d/48−d/32. Through the axial line-style slot structure 10112 having four air slots that are 90° apart, the mandrel of the invention has the effect of reducing stress.

The blind rivet, which is paired with the magnetic washer having a circular arc angle, can be used in settings of various directions. The magnetic washer having a circular arc angle 12 of the invention takes the advantage of its own strong magnetism made by production, along with the use of mandrels 10 and rivet bodies 11 with magnetic permeability, to be applied to objects to be mounted that are not horizontal to the gravity direction during the preassembling step B and the installing step C. The blind rivet 1 is secured firmly on to the object to be mounted 2 during steps of the single-sided operations through the magnetic washer having a circular arc angle 12.

While the invention has been described in terms of preferred embodiments, those skilled in the art will recognize that the invention can be practiced with modifications within the spirit and scope of the appended claims.

What is claimed is:

1. A blind rivet, comprising a mandrel, a rivet body, and a magnetic washer having a circular arc angle, wherein
the mandrel comprises a mandrel head and a shank, wherein the shank comprises a grip section, a groove section, and a pull section having a reverse tapered surface; and the shank diameter is d, wherein
the mandrel head is connected to one side of the grip section of the shank; the end surface of the mandrel head that is connected to one side of the shank has a circular arc surface with a radius of R;
the grip section is the portion of shank close to the mandrel head;
the groove section is disposed on the shank and connected with the grip section; the diameter of the groove section can be d−d/8−d−d/16; the groove section is configured with offset-style radial annular groove portions and an axial line-style slot structure separately; the axial line-style slot structure has four air slots that are 90° apart; the groove depth of the groove section can be d/48−d/32;
the pull section having a reverse tapered surface is disposed on the shank and connected with the groove section; the pull section having a reverse tapered surface is a conical structure, which has a reverse tapered surface angle of 3°-8°, and is configured with a structure of annular grooves having a reverse tapered surface; the annular grooves having a reverse tapered surface can increase the gripping force during the pulling process; owing to such a design, the length of the pull section having a reverse tapered surface can be reduced while the gripping force of the pull section having a reverse tapered surface of the mandrel remains unchanged; as a result, the overall length of the mandrel is reduced and the production cost is also reduced effectively;
the rivet body comprises a through hole that can match and be plugged with the mandrel, a rivet head, and a protruding edge structure; and
the magnetic washer having a circular arc angle has a through hole that can match and fit onto the mandrel, wherein one side of the washer has a circular arc surface with a radius of R that can engage and join with the circular arc surface with a radius of R of the mandrel head, and can automatically calibrate the deviation, caused by the eccentric force created during the pulling step, through the circular arc surface of radius R thereof.

2. The blind rivet of claim 1, wherein the magnetic washer having a circular arc angle has strong magnetism made by production.

3. The blind rivet of claim 1, wherein the mandrel and the rivet body have magnetic permeability made by production.
